(19) United States
(12) Patent Application Publication
(10) Pub. No.: US 2026/0133917 A1
(43) Pub. Date: May 14, 2026

(54) HIGH-BANDWIDTH MEMORY DEVICE WITH MEMORY DIE DATA BUS INVERSION

(71) Applicant: Micron Technology, Inc., Boise, ID (US)

(72) Inventors: Yongsuk Choi, Sugar Hill, GA (US); Dae Suk Kim, Sugar Hill, GA (US)

(21) Appl. No.: 19/338,283

(22) Filed: Sep. 24, 2025

Related U.S. Application Data
(60) Provisional application No. 63/720,754, filed on Nov. 14, 2024.

(51) Int. Cl. G06F 13/16; G06F 13/20

(52) U.S. Cl. CPC G06F 13/1684; G06F 13/20

(57) ABSTRACT

A high-bandwidth memory (HBM) device includes an interface die and a stack of memory dies. Each memory die includes a data bus inversion (DBI) circuit configured to perform DBI operations in response to a read command received from a host device communicably coupled to the HBM device (e.g., as part of a system-in-package). In response to the read command, the memory die is configured to determine whether it responded to the last read command received from the host device (e.g., based on comparing stack identifiers (SIDs) of the read commands). If the SIDs match, the DBI circuit enables DBI AC encoding, and if the SIDs do not match, the DBI circuit enables DBI DC encoding. The DBI-encoded read data (per DBI AC encoding or DBI DC encoding) is provided by the memory die via the interface die over through-silicon vias.

### CROSS-REFERENCE TO RELATED APPLICATION(S)

The present application claims priority to U.S. Provisional Patent Application No. 63/720,754, filed Nov. 14, 2024, the disclosure of which is incorporated herein by reference in its entirety.

### TECHNICAL FIELD

The present technology is generally related to vertically stacked semiconductor memory devices and, more specifically, to systems and methods for performing data bus inversion at memory dies within a high-bandwidth memory device.

### BACKGROUND

An electronic apparatus (e.g., a processor, a memory device, a memory system, or a combination thereof) can include one or more semiconductor circuits configured to store and/or process information. For example, the apparatus can include a memory device, such as a volatile memory device, a non-volatile memory device, or a combination device. Memory devices, such as dynamic random-access memory (DRAM) and/or high-bandwidth memory (HBM), can utilize electrical energy to store and access data.

With technological advancements in embedded systems and increasing applications, the market is continuously looking for faster, more efficient, and smaller devices. To meet market demands, semiconductor devices are being pushed to the limit with various improvements. Improving devices, generally, may include increasing circuit density, increasing circuit capacity, increasing operating speeds (or otherwise reducing operational latency), increasing reliability, increasing data retention, reducing power consumption, or reducing manufacturing costs, among other metrics. Attempts, however, to meet market demands, such as by reducing the overall device footprint, can often introduce challenges in other aspects, such as maintaining circuit robustness and/or failure detectability.

### BRIEF DESCRIPTION OF THE DRAWINGS

FIG. 1 is a partially schematic cross-sectional diagram of a system-in-package device.

FIG. 2 is a partially schematic cross-sectional diagram of a system-in-package device configured in accordance with some embodiments of the present technology.

FIG. 3 is a simplified block diagram schematically illustrating an on-die data bus inversion circuit configured in accordance with some embodiments of the present technology.

FIGS. 4A and 4B are simplified block diagrams schematically illustrating data bus inversion encoding circuits configured in accordance with some embodiments of the present technology.

FIG. 5 is a flow diagram illustrating a process for performing data bus inversion in accordance with some embodiments of the present technology.

The drawings have not necessarily been drawn to scale. Similarly, some components and/or operations can be separated into different blocks or combined into a single block for the purpose of discussion of some of the implementations of the present technology. Moreover, while the technology is amenable to various modifications and alternative forms, specific implementations have been shown by way of example in the drawings and are described in detail below. The intention, however, is not to limit the technology to the particular implementations described.

### DETAILED DESCRIPTION

High data reliability, high speed of memory access, lower power consumption, and reduced chip size are features that are demanded from semiconductor memory. In recent years, vertically stacked memory devices have been introduced, often referred to as 2.5-dimensional (“2.5D”) memory devices when placed adjacent to a host device or 3- dimensional (“3D”) memory devices when stacked on top of the host device. Some 2.5D or 3D memory devices are formed by stacking memory dies vertically and interconnecting the dies using through-silicon (or through-substrate) vias (TSVs). Benefits of the 2.5D and 3D memory devices include shorter interconnects (which reduce circuit delays and power consumption), a large number of vertical vias between layers (which allow wide bandwidth buses between functional blocks, such as memory dies, in different layers), and a considerably smaller footprint. Thus, the 2.5D and 3D memory devices contribute to higher memory access speed, lower power consumption, and chip size reduction. Example 2.5D and/or 3D memory devices include Hybrid Memory Cube (HMC) and High-Bandwidth Memory (HBM) devices. For example, HBM devices are a type of memory that includes a vertical stack of dynamic random-access memory (DRAM) dies and an interface die (which, e.g., provides the interface between the DRAM dies of the HBM device and a host device).

In a system-in-package (SiP) configuration, HBM devices may be integrated with a host device (e.g., a graphics processing unit (GPU), a computer processing unit (CPU), a tensor processing unit (TCU), and/or any other suitable processing unit) using a base substrate (e.g., a silicon interposer, a substrate of organic material, a substrate of inorganic material and/or any other suitable material that provides interconnection between the host device and the HBM device and/or provides mechanical support for the components of a SiP device), through which the HBM devices and host communicate. Because traffic between the HBM devices and host device resides within the SiP (e.g., using signals routed through the silicon interposer), a higher bandwidth may be achieved between the HBM devices and host device than in conventional systems. In other words, the TSVs interconnecting DRAM dies within an HBM device, and the silicon interposer integrating HBM devices and a host device, enable the routing of a greater number of signals (e.g., wider data buses) than is typically found between packaged memory devices and a host device (e.g., through a printed circuit board (PCB)). The high-bandwidth interface within a SiP enables large amounts of data to move quickly between the host device (e.g., GPU/CPU/TCU) and HBM devices during operation. For example, the high-bandwidth channels can be on the order of 1000 gigabytes per second (GB/s, sometimes also referred to as gigabits (Gb)). As a result, the SiP device can quickly complete computing operations once data is loaded into the HBM devices. SiP devices, in turn, are typically integrated with a package substrate (e.g., a PCB) adjacent to other electronics and/or other SiP devices within a packaged system.

Market demands on SiP devices and/or the HBM devices therein can present certain challenges, however. For example, as SiP devices and the HBM devices therein increase in functionality (e.g., add new features, increase in memory capacity, increase in bandwidth and/or frequency), it can be challenging to manage the power consumption of those devices. One approach that has been employed to reduce power consumption and improve power integrity is data bus inversion (DBI). As described herein, when DBI is employed, portions of data being transmitted between a host device and an HBM device (e.g., write data, from the host device, associated with a write command; or read data, from the HBM device, provided in response to a read command from the host) may be selectively inverted. Data may be inverted based on, for example, the number of bits within the data that are changing (e.g., from previously transmitted write data or read data), so as to reduce the number of bit transitions. For example, in approaches in which DBI is applied for 8-bit portions of data (e.g., each 8-bit portion of data can be individually inverted or not inverted), each portion may be inverted when four or more bits within the portion change (or are transitioning) from previous data to the current data. DBI can therefore minimize the switching activity of buses over which data is being transmitted, thereby reducing power consumption.

As described herein, when employed in an HBM device, DBI functions (e.g., determining whether to invert a portion of data and/or selectively generating inverted data) have conventionally been performed by the interface die of the HBM device (e.g., at the input/output (IO) PHYs of the interface die). Because the DBI functions are performed by the interface die, in said HBM devices the data is transmitted within the HBM device (e.g., between the memory dies and interface die) without being inverted. The benefits of DBI (e.g., reduced switching activity and improved power consumption) have therefore typically been realized on the buses between the host device and HBM device (e.g., within the SiP device), but not on the buses within the HBM device.

The systems and methods described herein address these and other shortcomings by further improving power consumption as a result of DBI. As described herein, HBM devices with memory die DBI perform DBI functions in response to a host read command at one or more of the memory dies that form the HBM device. By performing DBI functions at the memory die in response to a host read command (e.g., determining whether to invert a portion of read data and/or generating inverted read data), DBI-encoded read data (e.g., data that is selectively inverted) is generated at the memory dies and used for transmission through the HBM device (e.g., the buses between the memory dies and interface die). Switching activity is therefore reduced within the HBM device itself, in addition to the switching activity reductions conventionally yielded on buses between the HBM device and a host device, thereby further improving the benefits yielded by DBI.

As used herein, the terms “vertical,” “lateral,” “upper,” “lower,” “top,” and “bottom” can refer to relative directions or positions of features in the devices in view of the orientation shown in the drawings. For example, “bottom” can refer to a feature positioned closer to the bottom of a page than another feature. These terms, however, should be construed broadly to include devices having other orientations, such as inverted or inclined orientations where top/bottom, over/under, above/below, up/down, and left/right can be interchanged depending on the orientation.

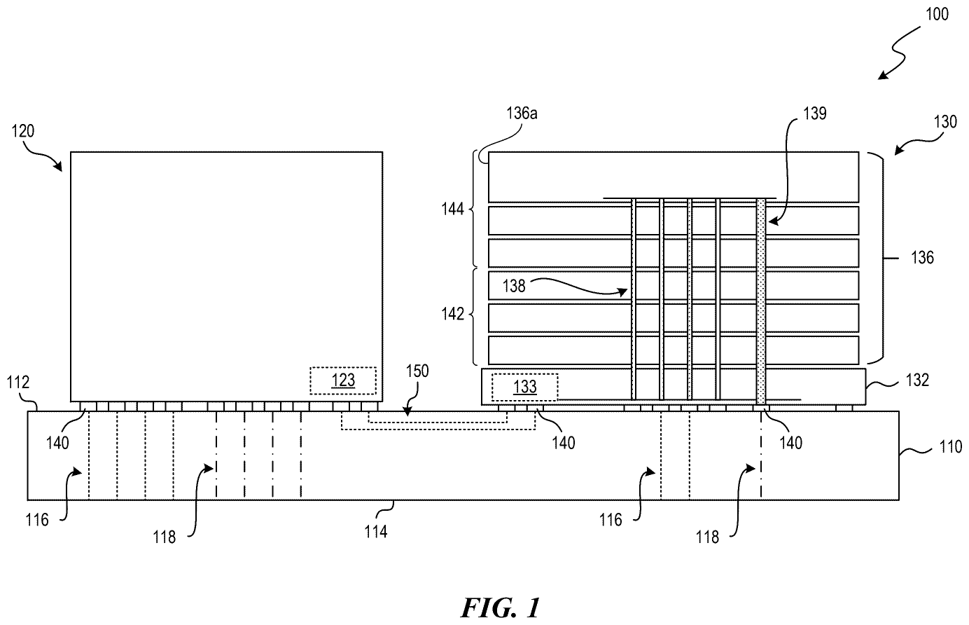

FIG. 1 is a partially schematic cross-sectional diagram of a SiP device 100. As illustrated in FIG. 1, the SiP device 100 includes a base substrate 110 (e.g., a silicon interposer, another organic interposer, an inorganic interposer, and/or any other suitable base substrate), as well as a host device 120 and an HBM device 130 each integrated with (e.g., carried by and coupled to) an upper surface 112 of the base substrate 110 through a plurality of interconnect structures 140 (three labeled in FIG. 1). The interconnect structures 140 can be solder structures (e.g., solder balls), metal-metal bonds, bumps, micro bumps, and/or any other suitable conductive structure that mechanically and electrically couples the base substrate 110 to each of the host device 120 and the HBM device 130. Further, the host device 120 is coupled to the HBM device 130 through one or more communication channels 150 formed in the base substrate 110 (sometimes referred to as a SiP bus). The communication channels 150 can include one or more route lines (two illustrated schematically in FIG. 1) formed into (or on) the base substrate 110.

As further illustrated in FIG. 1, the base substrate 110 includes a plurality of external signal TSVs 116 and a plurality of external power TSVs 118 extending between the upper surface 112 and a lower surface 114 of the base substrate 110. The external signal TSVs 116 can communicate signals (e.g., data, control signals, processing commands, and/or the like) between the host device 120 and/or the HBM device 130 and an external component (e.g., a PCB the base substrate 110 is integrated with, an external controller, and/or the like). The external power TSVs 118 provide electrical power to the host device 120 and/or the HBM device 130 from an external power source.

The host device 120 can include a variety of components, such as a processing unit (e.g., CPU/GPU/TCU), one or more registers, one or more cache memories, and/or a variety of other components (not shown). In the illustrated environment, the host device 120 additionally includes a host IO circuit 123 that can direct signals to and/or from the HBM device 130 through the communication channels 150. Additionally, or alternatively, the host IO circuit 123 can direct signals to and/or from an external component (e.g., a controller coupled to one or more of the external signal TSVs 116 and/or the like).

The HBM device 130 can include an interface die 132, and a stack of one or more memory dies 136 (six illustrated in FIG. 1), each including one or more memory arrays (e.g., DRAM), carried by the interface die 132. The HBM device 130 also includes one or more signal TSVs 138 (four illustrated in FIG. 1) and one or more power TSVs 139 (one illustrated in FIG. 1) each extending from the interface die 132 to an uppermost memory die 136a. The power TSV(s) 139 provide power (e.g., received from one or more of the external power TSVs 118) to the interface die 132 and each of the memory dies 136. The signal TSVs 138 communicably couple each of the memory dies 136 to an IO circuit 133 in the interface die 132 (in addition to various other circuits in the interface die 132). In turn, the IO circuit 133 can direct signals to and/or from the host device 120 and/or an external component (e.g., an external storage device coupled to one or more of the external signal TSVs 116 and/or the like).

The HBM device 130 may include multiple independent interfaces, or channels, used for communication between the HBM device 130 and host device 120. Each channel may consist of an independent command and data interface and may include a data bus (DQ), command and address buses (e.g., command and/or address buses for columns and rows), clock signals, and other control signals. In other words, for each channel of the HBM device 130, the host device 120 may independently transmit a command to the HBM device 130, transmit data over a DQ bus (e.g., as part of a write command), receive data over a DQ bus (e.g., in response to a read command), etc. The per-channel interface of the HBM device 130 may be provided by the IO circuit 133, and per-channel signaling within the HBM device 130 provided over the signal TSVs 138 (e.g., each independent channel may be associated with a corresponding independent set of signal TSVs 138). The HBM device 130 may have 8, 16, 32, etc. independent channels, each of which may have a DQ bus of 64, 128, 256, etc. bits.

Each channel of the HBM device 130 provides access to an independent set of DRAM banks, and requests from one channel may not access data attached to a different channel (e.g., a read request over channel 0 may not access a DRAM bank attached to channel 1). The DRAM attached to a channel may be distributed over one or more memory dies 136, and each memory die 136 may support (e.g., contain the DRAM banks for) one or more channels. When the memory for a single channel is distributed among multiple memory dies 136, each of the memory dies 136 providing DRAM for that channel are organized into different stacks into which the HBM device 130 is divided. Stacks of the HBM device 130, each of which is associated with a unique stack identifier (SID), may include one or more memory dies 136, and each stack provides memory capacity for all of the channels of the HBM device 130. For example, in an HBM device with eight independent channels and two stacks, both of the two stacks provide memory capacity (by the one or more memory dies within each stack) to all eight of the channels. FIG. 1 illustrates an example HBM device 130 with a first stack 142 (associated with a first SID) comprising the lower three memory dies 136, and a second stack 144 (associated with a second SID) comprising the upper three memory dies 136. HBM devices may however include greater or fewer stacks, each with greater or fewer memory dies.

The HBM device 130 and the host device 120 may be configured to utilize DBI, in which portions of a data bus (e.g., portions of a DQ bus associated with a channel) are selectively inverted to reduce switching activity. DBI may be used for write data (e.g., data from the host device 120 associated with a write command) and read data (e.g., data from the HBM device 130 provided in response to a read command), where the DBI decision (e.g., whether or not to invert) is made by the transmitter (e.g., the host device 120 for writes and the HBM device 130 for reads). The transmitter (e.g., the host device 120 for writes and the HBM device 130 for reads) may indicate to the receiver (e.g., the HBM device 130, and host device 120, respectively) whether or not a portion of data (e.g., a portion of the DQ bus) has been inverted based on a corresponding DBI flag. For example, in an HBM device 130 where each channel's DQ bus is 128 bits and DBI is applied to 8 bit portions of the DQ bus, each channel may include 16 DBI flags that are driven by the transmitter and indicate whether the corresponding 8 bits of the DQ bus have been inverted. Whether or not to invert a portion of the DQ bus may be based on the number of bits within that portion that are transitioning from a previous state (e.g., a previous read or a previous write), as defined for example by the JEDEC HBM specification (e.g., HBM2, HBM3, HBM3E, etc.).

In the HBM device 130, DBI functions may be performed by the interface die 132 (e.g., by the IO circuit 133 and/or another component of the interface die 132, not shown). For example, in response to a read command from the host device 120, the interface die 132 may evaluate read data (received from a memory die 136 via signal TSVs 138), determine whether to invert one or more portions of the read data (based, for example, on the number of bits within the portions that are transitioning from prior read data), and selectively generate inverted data portions. The HBM device 130 may then transmit the read data (where some portions may be inverted and some portions not inverted) over the DQ bus of the channel over which the read command was received and corresponding DBI flag signals to the host device 120 via the communication channels 150. In other words, in the HBM device 130, the benefits of DBI following a read command (e.g., less switching activity and reduced power consumption) are realized on the communication path between the HBM device 130 and the host device 120 (e.g., communication channels 150), but not on the communication paths within the HBM device 130 (e.g., the signal TSVs 138 over which the read data from a memory die 136 is transmitted).

HBM devices with memory die DBI and related systems and methods that address the shortcomings discussed above are disclosed herein. As described in greater detail herein, HBM devices of the present technology perform one or more DBI-related operations, in response to a read command received from a host device, at the memory dies that make up the HBM devices. For example, in response to a read command including a read address, data is read from a memory die of the HBM device (and memory array therein) associated with the read address. The memory die is configured to evaluate the read memory array data to determine whether the data, or any portions thereof, should be inverted. As described herein, determining whether to invert individual portions of the memory array data may be based on whether inverting the data portion will reduce switching activity. The memory die is further configured to generate read data based on the memory array data, where individual portions of the memory array data are selectively inverted to generate the corresponding read data portion and DBI flags corresponding to each of the read data portions. The read data and DBI flags are then transmitted from the memory die to an interface die of the HBM device (e.g., over TSVs communicably coupling the memory die to the interface die) and, ultimately, transmitted to the host device. Since, as described in greater detail below, in HBM devices of the present technology the read data is selectively inverted at the memory dies (alternatively referred to as DBI-encoded), before the DBI-encoded read data is transmitted through the HBM device, the power reduction provided by DBI is improved.

As described herein, one challenge with performing DBI operations at the memory dies of an HBM device is that different memory dies within the HBM device may provide the read data for consecutive read commands received over the same channel. Therefore, DBI encoding algorithms that rely on previous read data to evaluate the number of bit transitions (e.g., as illustrated by the HBM3 specification), when performed at a memory die, may generate incorrect results due to previous read data being unavailable at a memory die (e.g., when the previous read data was read from a different memory die in the HBM device). Accordingly, in some embodiments of the present technology, HBM devices with memory die DBI are configured to determine whether consecutive read commands (of a channel) are associated with the same memory die (e.g., both read commands have read addresses that result in reading data from the same memory die). As described herein, the HBM devices of the present technology may utilize different DBI encodings (e.g., utilize different algorithms to determine whether a data portion should be inverted) based on whether consecutive read commands of a channel are associated with the same memory die. In some embodiments, and as discussed in greater detail below, a memory die responding to a current read command determines whether it also responded to the last read command based on the SIDs associated with the current read command and last read command. For example, the memory die may utilize one DBI encoding when the SIDs of the current read command and last read command match (indicating that the same memory die also responded to the last read command), and it may utilize another DBI encoding when the SIDs of the current read command and the last read command do not match (indicating that a different memory die responded to the last read command).

In some embodiments of the present technology, when a memory die responding to a current read command determines that it responded to the previous read command (e.g., based on matching the current read command and previous read command being associated with the same SID), the memory die utilizes a DBI encoding algorithm that evaluates current read data and previous read data to determine whether to invert portions of the current read data. DBI encoding that utilizes previous read data to determine whether to invert portions of data is referred to herein as DBI AC encoding or DBIac encoding. In some embodiments, when DBIac encoding is used, the memory die determines whether to invert a data portion based on the number of bits switching between previous read data and current read data (e.g., changing from a binary 0 to a binary 1, or changing from a binary 1 to a binary 0) within the data portion. For example, in embodiments of the present technology in which DBIac encoding is applied individually to 8-bit data portions, an individual data portion is inverted if 5-8 bits change between the past read data and current data, is not inverted if 0-3 bits change, and retains the previous DBI decision if 4 bits change (e.g., inverts if the previous read data was inverted, does not invert if the previous read data was not inverted).

In some embodiments of the present technology, when a memory die responding to a current read command determines that it did not respond to the previous read command (e.g., based on the current read command and the previous read command being associated with different SIDs), the memory die utilizes a DBI encoding algorithm that evaluates current read data but does not evaluate read data of a previous read command to determine whether to invert portions of the current read data. DBI encoding that utilizes current read command read data but does not utilize read data of a previous read command to determine whether to invert portions of the read data of the current read command is referred to herein as DBI DC encoding or DBIdc encoding. In some embodiments, when DBIdc encoding is used, the memory die determines whether to invert a data portion based on the number of zero bits (bits set to 0) within the data portion. For example, in embodiments of the present technology in which DBIdc is applied individually to 8-bit data portions, an individual data portion is inverted if 5-8 bits are zero bits set to 0.

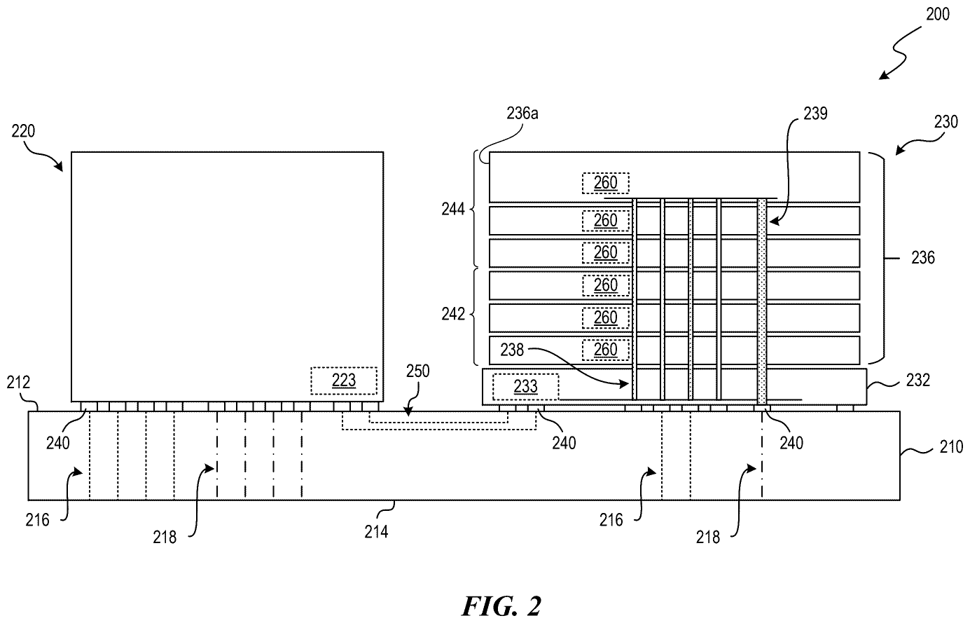

Additional details of HBM devices with memory die DBI and related systems and methods are discussed below with reference to FIGS. 2-5.

FIG. 2 is a partially schematic cross-sectional diagram of a SiP device 200 configured in accordance with some embodiments of the present technology. In FIG. 2, elements labeled with reference numerals in the 2xx series (e.g., 200, 210, 230, etc.) correspond to and are substantially similar in structure and function to their counterparts in FIG. 1 labeled with reference numerals in the 1xx series (e.g., 100, 110, 130, etc.), respectively, unless explicitly described otherwise herein.

As illustrated in FIG. 2, the SiP device 200 can include a base substrate 210, as well as an HBM device with memory die DBI 230 (“HBM device 230”) and host device 220, each integrated with (e.g., carried by and coupled to) an upper surface 212 of the base substrate 210 by interconnect structures 240. The base substrate 210 can include one or more external signal TSVs 216 (six illustrated in FIG. 2) and one or more external power TSVs 218 extending between the upper surface 212 (sometimes also referred to herein as an “active surface”) and a lower surface 214 of the base substrate 210. The external signal TSVs 216, via the interconnect structures 240, allow the host device 220 and HBM device with memory die DBI 230 to receive signals from, and send signals to, another component coupled to the lower surface 214 of the base substrate 210 (e.g., from another controller coupled to a PCB the SiP device 200 is coupled to and/or the like). Similarly, the external power TSVs 218, via the interconnect structures 240, allow the host device 220 and HBM device with memory die DBI 230 to receive power from another component coupled to the lower surface 214 of the base substrate 210 (e.g., from the PCB the SiP device 200 is coupled to and/or the like).

The host device 220 can include a variety of components, such as a processing unit (e.g., CPU/GPU/TCU), one or more registers, one or more cache memories, and/or a variety of other components (not shown). In the illustrated environment, the host device 220 additionally includes a host IO circuit 223 that can direct signals to and/or from the HBM device 230 through the communication channels 250. Additionally, or alternatively, the host IO circuit 223 can direct signals to and/or from an external component (e.g., a controller coupled to one or more of the external signal TSVs 216 and/or the like).

The HBM device with memory die DBI 230 can include an interface die 232, and a stack of one or more memory dies 236 (six illustrated in FIG. 2), each including one or more memory arrays (e.g., DRAM), carried by the interface die 232. The HBM device 230 also includes one or more signal TSVs 238 (four illustrated in FIG. 2) and one or more power TSVs 239 (one illustrated in FIG. 2) each extending from the interface die 232 to an uppermost memory die 236a. The power TSV(s) 239 provide power (e.g., received from one or more of the external power TSVs 218) to the interface die 232 and each of the memory dies 236. The signal TSVs 238 communicably couple each of the memory dies 236 to an IO circuit 233 in the interface die 232 (in addition to various other circuits in the interface die 232). In turn, the IO circuit 233 can direct signals to and/or from the host device 220 and/or an external component (e.g., an external storage device coupled to one or more of the external signal TSVs 216 and/or the like).

The HBM device with memory die DBI 230 may include multiple independent channels (e.g., 8, 16, 32 channels), each used for communication between the HBM device 230 and host device 220, each of which consists of an independent command and data interface, including DQ bus (of 64, 128, 256, etc. data bits), command and addresses buses, clock signals, and other control signals. The per-channel interface of the HBM device 230 may be provided by the IO circuit 233, and per-channel signaling within the HBM device 230 provided over the signal TSVs 238 (e.g., each independent channel may be associated with a corresponding independent set of signal TSVs 238).

Each channel of the HBM device 230 provides access to an independent set of DRAM banks, and requests from one channel may not access data attached to a different channel. The DRAM attached to a channel may be distributed over one or more memory dies 236, and each memory die 236 may support (e.g., contain the DRAM banks for) one or more channels. When the memory for a single channel is distributed among multiple memory dies 236, each of the memory dies 136 providing DRAM for that channel are organized into different stacks into which the HBM device 230 is divided. Each stack is associated with a SID and may include one or more memory dies 236. FIG. 2 illustrates an example HBM device 230 with a first stack 242 (associated with a first SID) comprising the lower three memory dies 236, and a second stack 244 (associated with a second SID) comprising the upper three memory dies 236. HBM devices may, however, include greater or fewer stacks, each with greater or fewer memory dies.

The HBM device 230 and the host device 220 may be configured to utilize DBI, in which portions of a data bus (e.g., portions of a DQ bus associated with a channel) are selectively inverted to reduce switching activity. In the HBM device 230, certain DBI functions may be performed by the interface die 232. For example, as part of a write command from the host device 220, the host device 220 may indicate which portions of a DQ bus (containing the write data) have been inverted (based on corresponding DBI flags transmitted by the host device 220). The interface die 232 may invert the DQ portions based on the corresponding DBI flags and transmit the DBI-decoded write data to the appropriate memory dies 236 for writing to the memory array.

As illustrated in FIG. 2, other DBI functions of the HBM device 230 are performed by each of the memory dies 236 and the DBI circuits 260 therein. In particular, the DBI circuit 260 performs DBI operations (e.g., determines whether to invert one or more data portions and/or generates DBI-encoded data based on the determination) in response to a read command received or detected from the host device 220 (i.e., when the HBM device 230 is the transmitter that provides read data to the host device 220). That is, in response to a read command received by the HBM device 230 from the host device 220 over a channel, one of the memory dies 236 (e.g., the memory die 236 associated with a read address received with the read command) reads the requested data from a memory array therein. The DBI circuit 260 of the memory die 236 evaluates the read memory array data, determines whether the memory array data (in its entirety and/or individual portions thereof) should be inverted, and generates output data in which portions are selectively inverted based on the determination (i.e., DBI-encoded read data). As described herein, to determine whether to invert memory array data, the DBI circuit 260 additionally determines whether data from the last read command from the host device 220 is available at the memory die 236.

In some embodiments, the DBI circuit 260 determines whether data from the last read command from the host device 220 is available at the memory die 236 based on comparing SIDs associated with the last read command and the current read command. For example, each read command from the host device 220 may include a read address (i.e., the address to be read), which may include an SID. As described herein, the SID of the address may be used to identify a stack, of the multiple stacks (e.g., first stack 242 and second stack 244) forming an HBM device 230, in which requested memory is found. Further, in some embodiments of the HBM device 230, the memory accessible by a channel is provided by one memory die 236 per stack. In other words, in some embodiments, the SID portion of an address indicates which memory die 236 contains the memory associated with a host command. In said embodiments, different read commands received from the host device 220 over the same channel, having the same SID, are associated with the same memory die 236. To determine whether SIDs of different read commands match, the DBI circuit 260 may include a storage element (e.g., a latch, flip-flop, register, or other state-saving component) that maintains the SID of the last read command received from the host device 220. The storage element may be enabled by read commands, such that the storage element updates the stored SID value with read commands (e.g., if on subsequent clock cycles the host sends no commands, the stored SID value is maintained). When a read command is received from the host device 220, the DBI circuit 260 may compare the SID associated with the read command and the SID stored in the storage element (associated with the last read command from the host) to determine whether the SIDs of the current and previous read commands are the same. When the SIDs of a current read command and last read command match, indicating that the same memory die 236 responded to the last read command, that further indicates that the read data associated with the last read command is resident in the memory die 236 (e.g., in storage elements, such as latches, that had been used to drive the read data to the interface die 232 via the signal TSVs 238, during the last read). As described herein, the read data of the last read command is therefore available for forming DBI decisions (e.g., whether or not to invert portions of data).

When the DBI circuit 260 determines that read data from the last read command is available at the memory die 236 (i.e., the same memory die 236 responding to the current read command), the DBI circuit 260 determines whether to invert one or more portions of the memory array data based on an evaluation that includes the read data from the last read command (e.g., utilizes DBIac encoding). When utilizing DBIac encoding, in some embodiments the DBI circuit 260 determines whether to invert portions of the memory array data based on the number of bits transitioning or switching in value when comparing the read data from the last read command and the memory array data (i.e., the data read in response to the current read command).

When the DBI circuit 260 determines that read data from the last read command is not available at the memory die 236, the DBI circuit 260 determines whether to invert one or more portions of the memory array data based on an evaluation that does not take into account previous read data (e.g., utilizes DBIdc encoding). When utilizing DBIdc encoding, in some embodiments the DBI circuit 260 determines whether to invert portions of the memory array data based on a count of the number of 0 bits in each portion of the memory array data.

Although FIG. 2 illustrates one DBI circuit 260 per memory die 236, it will be appreciated that each memory die 236 may include one or more DBI circuits 260. For example, a DBI circuit 260 may perform DBI operations (e.g., determine whether to invert data, and generate inverted data) for an individual portion of data (e.g., 8 bits, 16 bits, etc.), and the memory die 236 may include multiple DBI circuits 260 each performing DBI operations on a different portion of read data (e.g., a first DBI circuit for bits 0-7 of read data, a second DBI circuit for bits 8-15 of read data, etc.). As a further example, in embodiments in which a memory die 236 includes the DRAM banks of multiple channels of the HBM device 230, the memory die 236 may include multiple DBI circuits 260 each associated with an individual channel. In other words, in some embodiments, DBI operations performed in association with read commands received over a first channel of the HBM device 230 are independent of DBI operations performed and associated with read commands received over a second channel of the HBM device 230.

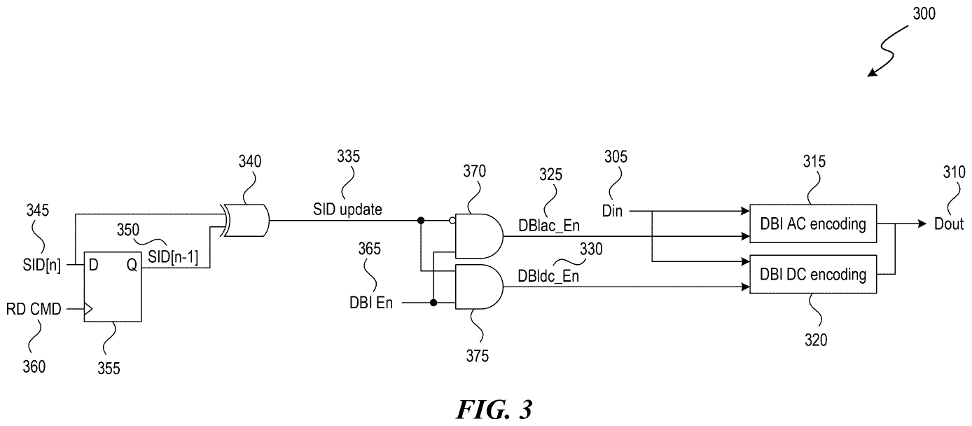

FIG. 3 is a simplified block diagram schematically illustrating an on-die DBI circuit 300 configured in accordance with some embodiments of the present technology. In some embodiments, the on-die DBI circuit 300 can be implemented within and/or illustrate the operation of one or more DBI circuits 260 (illustrated in FIG. 2). That is, for example, each DBI circuit 260 of FIG. 2 may include one or more on-die DBI circuits 300.

As described herein, the on-die DBI circuit 300 evaluates input data Din 305 and generates output data Dout 310, where Dout 310 represents a DBI-encoded form of Din 305. Dout 310 may be encoded by a DBI AC encoding block 315 or a DBI DC encoding block 320, where DBI AC encoding block 315 is selectively enabled by a DBIac_En signal 325, and DBI DC encoding block 320 is selectively enabled by a DBIdc_En signal 330. In some embodiments, neither DBI AC encoding block 315 nor DBI DC encoding block 320 may be enabled (based on DBIac_En signal 325 and DBIdc_En signal 330, respectively), in which case Dout 310 is the same as Din 305 (e.g., no DBI encoding is performed).

The DBIac_En signal 325 and DBIdc_En signal 330 are both generated in part based on an SID update signal 335, which indicates whether the SIDs associated with two consecutive read commands are different. To generate SID update signal 335, the on-die DBI circuit 300 performs a comparison (e.g., at XOR gate 340) between a SID[n] signal 345 and a SID[n-1] signal 350. The SID[n] signal 345, which may indicate the SID associated with a current read command, is also used as the data input to a storage element 355 (e.g., a flip-flop), and the SID[n-1] signal 350 is driven by the data output of the storage element 355. Further, the storage element 355 is clocked and/or enabled by a RD CMD signal 360, which asserts with a read command from a host device. In other words, SID[n] signal 345 indicates the SID of a current read command, and SID[n-1] signal 350 represents the SID of the last received read command (since storage element 355 only updates on read commands). SID update signal 335 therefore indicates whether the SIDs of the current and previous read command are the same.

In some embodiments, the storage element 355 may be reset by a reset signal (not shown). For example, the storage element 355 may be reset when a host device issues a write command, when the host sets a mode register, and/or when the HBM device exits a self-refresh mode.

The SID update signal 335 is further qualified by a DBI En signal 365, at AND gate 370 and AND gate 375, to generate DBIac_En signal 325 and DBIdc_En signal 330, respectively. The DBI En signal 365 indicates whether DBI is enabled, as controlled by a mode register or other configuration setting. Additionally, the SID update signal 335 is inverted at the input of AND gate 370 but not inverted at the input of AND gate 375. In other words, when SID update signal 335 asserts (indicating a change in SID from the last read command) then the DBIdc_En signal 330 asserts, and when SID update signal 335 de-asserts (indicating the same SID from the last read command) then the DBIac_En signal 325 asserts (so long as DBI is enabled, as indicated by the DBI En signal 365).

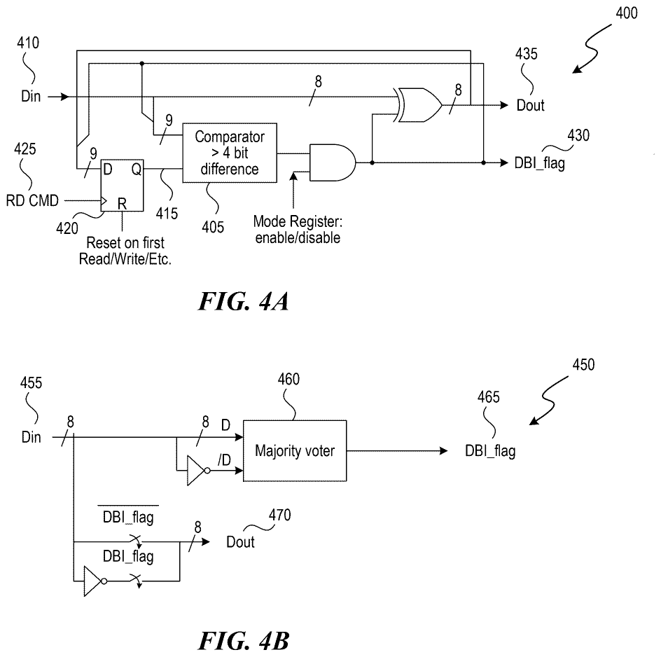

FIGS. 4A and 4B are simplified block diagrams schematically illustrating a DBI AC encoding circuit 400 and a DBI DC encoding circuit 450, respectively, configured in accordance with some embodiments of the present technology. The DBI AC encoding circuit 400 may, for example, be implemented as part of the DBI AC encoding block 315 (illustrated in FIG. 3), and the DBI DC encoding circuit 450 may, for example, be implemented as part of the DBI DC encoding block 320 (illustrated in FIG. 3).

The DBI AC encoding circuit 400 of FIG. 4A performs a comparison (e.g., at a comparator 405) between input data Din 410 and the Q output 415 of a storage element 420 (e.g., a flip-flop, latch, etc.). The comparator 405 determines the number of bits that differ between Din 410 and Q output 415. Din 410 may represent data read from a DRAM or other memory array in response to a read command, and as reflected in FIG. 4A, the storage element 420 is enabled by a RD CMD signal 425. In other words, Din 410 is associated with data read in response to a current read command, Q output 415 is associated with data read in response to a previous read command, and the comparator 405 determines the number of bit transitions between the current and previous read data.

Based on the result of the comparator 405 (e.g., whether the number of bit transitions, between the current and previous read data, exceeds a threshold), the DBI AC encoding circuit 400 generates a DBI_flag 430, which indicates whether data (e.g., of the current read command) is being inverted. The DBI AC encoding circuit 400 further generates output data Dout 435 based on the XOR of Din 410 and DBI_flag 430 (i.e., Dout 435 is the inversion of Din 410 when DBI_flag 430 asserts). Dout 435 and DBI_flag 430 are both provided as DBI AC encoding circuit 400 outputs (e.g., as DQ or a portion thereof, and DBI, respectively). Further, Dout 435 and DBI_flag 430 are both used to update the Q output 415 of the storage element 420 (e.g., as controlled by RD CMD signal 425).

As illustrated in FIG. 4A, the storage element 420 may be reset under certain conditions. For example, the storage element 420 may be reset when a host device issues its first read command (e.g., following a write command or other command), when the host device issues a write command, etc. As further illustrated in FIG. 4A, the generation of DBI_flag 430 (and inversion of Din 410) may be qualified by an enable/disable signal (e.g., at a mode register), that indicates whether DBI is enabled.

The DBI DC encoding circuit 450 of FIG. 4B determines whether input data Din 455 has a majority of bits set to 0 or 1 (at a majority voter block 460), based on which it generates a DBI_flag 465. For example, in some embodiments, the majority voter block 460 sets DBI_flag 465 if the majority of bits of Din 455 are set to 0. Based on DBI_flag 465, the DBI DC encoding circuit 450 generates output data Dout 470 as the true or inverted value of Din 455. Dout 470 and DBI_flag 465 are both provided as DBI DC encoding circuit 450 outputs (e.g., as DQ or a portion thereof, and DBI, respectively).

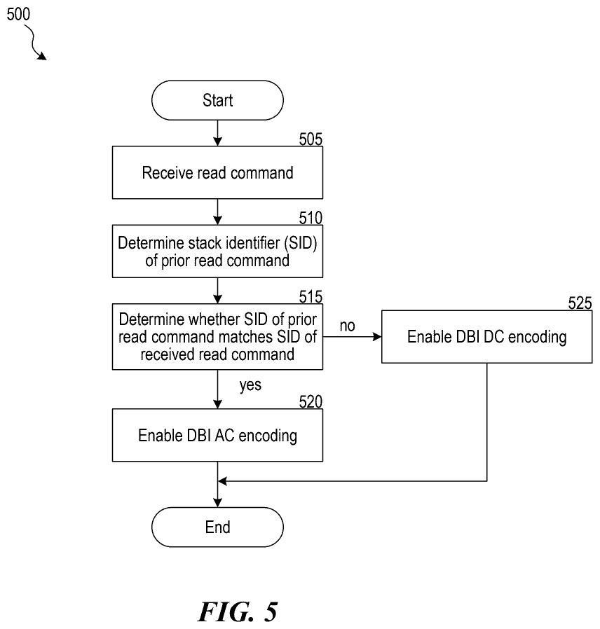

FIG. 5 is a flow diagram illustrating a process 500 for performing DBI in accordance with some embodiments of the present technology. Aspects of the process 500 can be performed, for example, by a memory die of an HBM device (e.g., a memory die 236 of HBM device 230 illustrated in FIG. 3), an on-die DBI circuit (e.g., DBI circuit 260 of FIG. 3), or a combination thereof.

The process 500 begins at block 505, where the process receives or detects a read command. The read command may be received from a host device communicably coupled to the HBM device (and memory die therein), and the read command may be associated with a request for data stored at the memory die. The read command may be associated with an SID.

At block 510, the process determines the SID of a previous read command. The SDI of the previous read command may be maintained, for example, in a storage element that is local to the memory device. The storage element may be configured to update only on read commands, so that the storage element stores the SID of the last read command.

At block 515, the process determines whether the SID of the current read command (e.g., received at block 505) and the SID of the last read command (e.g., determined at block 510) are the same. If the SIDs are the same, the process continues to block 520. If the SIDs differ, the process continues to block 525.

If at block 515 it was determined that the SIDs match, then at block 520 the process enables DBI AC encoding of the read data associated with the read command (e.g., received at block 505). The process 500 then ends.

If at block 515 it was determined that the SIDs do not match, then at block 525 the process enables DBI DC encoding of the read data associated with the read command (e.g., received at block 505). The process 500 then ends.

From the foregoing, it will be appreciated that specific embodiments of the technology have been described herein for purposes of illustration, but well-known structures and functions have not been shown or described in detail to avoid unnecessarily obscuring the description of the embodiments of the technology. To the extent any material incorporated herein by reference conflicts with the present disclosure, the present disclosure controls. Where the context permits, singular or plural terms may also include the plural or singular term, respectively. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Further, the terms “approximately,” “generally,” and/or “about” are used herein to mean within at least 10% of a given value or limit. Purely by way of example, an approximate ratio means within 10% of the given ratio.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

From the foregoing, it will also be appreciated that various modifications may be made without deviating from the disclosure or the technology. For example, one of ordinary skill in the art will understand that various components of the technology can be further divided into subcomponents, or that various components and functions of the technology may be combined and integrated. In addition, certain aspects of the technology described in the context of particular embodiments may also be combined or eliminated in other embodiments.

Furthermore, although advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

I/We claim:

1. A high-bandwidth memory (HBM) device, comprising:
an interface die comprising an input/output (IO) circuit;
a stack of one or more memory dies carried by the interface die, each of the one or more memory dies comprising a data bus inversion (DBI) circuit configured to:
generate, based on first memory data comprising a number of bits, a first DBI flag based on a majority of first memory data bits having a binary 0 value;
generate a second DBI flag based on a number of bit transitions from second memory data, the second memory data comprising the number of bits, to the first memory data;
generate an output DBI flag based on selecting the first DBI flag or the second DBI flag; and
generate, based on the output DBI flag, a data output comprising the first memory data or an inversion of the first memory data; and
a plurality of through-silicon vias (TSVs) communicably coupling the IO circuit and a memory die of the one of the one or more memory dies, wherein the output DBI flag and the data output of the memory die are transmitted to the IO circuit over the plurality of TSVs.

2. The HBM device of claim 1, wherein each of the one or more memory dies comprises a memory array, and wherein the first memory data is read from the memory array in response to a first read command received from a host device, and the second memory data is read from the memory array in response to a second read command received from the host device.

3. The HBM device of claim 2, wherein the second read command is received from the host device at a clock cycle prior to receiving the first read command.

4. The HBM device of claim 1,
wherein the DBI circuit is further configured to:
determine, from a first command associated with the first memory data, a first stack identifier (SID); and
determine, from a second command associated with the second memory data, a second SID;
wherein generating the output DBI flag based on selecting the first DBI flag or the second DBI flag comprises:
selecting the first DBI flag when the first SID is different than the second SID; and
selecting the second DBI flag when the first SID is the same as the second SID.

5. The HBM device of claim 1, wherein the number of bits is 8.

6. The HBM device of claim 1, wherein each of the one or more memory dies comprises a plurality of memory data and a plurality of DBI circuits, and wherein each of the DBI circuits of each of the one or more memory dies is configured to generate a corresponding output DBI flag and data output based on one of the plurality of memory data.

7. The HBM device of claim 6, wherein the memory die is configured to generate a read output comprising the plurality of data outputs generated by the plurality of DBI circuits.

8. A system-in-package (SiP) device, comprising:
a base substrate;
a host device carried by the base substrate; and
a high-bandwidth memory (HBM) device carried by the base substrate, the HBM device communicably coupled to the host device by the base substrate, wherein the HBM device comprises an interface die and a stack of one or more memory dies carried by the interface die, and wherein each of the one or more memory dies is configured to:
maintain, in a storage element, a prior stack identifier (SID);
determine, based on a read command received from the host device; a current SID;
enable data bus inversion (DBI) AC encoding when the prior SID is the same as the current SID;
enable DBI DC encoding when the prior SID is different from the current SID; and
update the storage element based on the current SID.

9. The SiP device of claim 8, wherein storage element updates are enabled when the memory die detects a read command.

10. The SiP device of claim 8, wherein each of the one or more memory dies is further configured to reset the storage element based on detecting a write command.

11. The SiP device of claim 8, wherein enabling DBI AC encoding is based further on a DBI enable signal, and wherein enabling DBI DC encoding is based further on the DBI enable signal.

12. The SiP device of claim 11, wherein the DBI enable signal is based on a mode register.

13. The SiP device of claim 8, wherein when a memory die enables DBI AC encoding, the memory die is further configured to:
read, from a memory array of the memory die, memory data in response to the read command;
compare the memory data to prior read data;
determine, based on the comparison, a number of bit differences between the memory data and the prior read data; and
generate a DBI flag based on the number of bit differences.

14. The SiP device of claim 8, wherein when a memory die enables DBI DC encoding, the memory die is further configured to:
read, from a memory array of the memory die, memory data in response to the read command;
determine a number of bits of the memory data having a binary 0 value; and
generate a DBI flag based on whether the number of bits having a binary 0 value is a
majority of the memory data bits.

15. A method, comprising:
receiving, at a high-bandwidth memory (HBM) device, a read command from a host coupled to the HBM device, wherein the read command comprises a first stack identifier (SID);
determining, at a memory die of the HBM device, a second SID associated with a previous read command;
reading, at the memory die, memory data from a memory array in response to the read command;
comparing, at the memory die, the first SID and the second SID to determine whether the first SID matches the second SID;
enabling data bus inversion (DBI) AC encoding of the memory data when the first SID and second SID match; and
enabling DBI DC encoding of the memory data when the first SID and the second SID do not match.

16. The method of claim 15, further comprising:
when DBI AC encoding is enabled:
comparing the memory data to prior read data;
determining, based on the comparison, a number of bit differences between the memory data and the prior read data; and
generating a DBI flag based on the number of bit differences.

17. The method of claim 15, further comprising:
when DBI DC encoding is enabled:
determining a number of bits of the memory data having a binary 0 value; and
generating a DBI flag based on whether the number of bits having a binary 0 value is a majority of the memory data bits.

18. The method of claim 15, further comprising:
maintaining the second SID in a storage element of the memory die; and
updating the storage element with the first SID.

19. The method of claim 18, wherein updating the storage element is enabled when the memory die detects a read command.

20. The method of claim 18, further comprising:
resetting the storage element based on detecting a write command from the host device.
